(19) United States
(12) Patent Application Publication
(10) Pub. No.: US 2004/0209576 A1
(43) Pub. Date: Oct. 21, 2004

(54) Decorative headset for a cellular phone and method of making same

(76) Inventor: Chung-Hoon Lee, Mamaroneck, NY (US)

Correspondence Address: Thomas A. Gallagher, Esq., 65 Woods End Road, Stamford, CT, 06905, US

(21) Appl. No.: 10/417,276

(22) Filed: Apr. 16, 2003

(51) Int. Cl. H04B 1/38; H04M 1/00

(52) U.S. Cl. 455/90.3; 455/550.1

(57) ABSTRACT

A decorative headset for a cellular phone has metallic covers on the earpiece and the microphone. The metallic covers are formed to have an outer surface topography of raised and/or lowered portions. Decorative material is placed between the raised or within the lowered portions of the outer surface. According to one embodiment, the decorative material is an enamel paint or material with a similar appearance. According to another embodiment, the decorative material is real or imitation gemstones. The headset is very attractive and resembles an earring type of jewelry.

### BACKGROUND OF THE INVENTION

1. Field of the Invention

This invention relates broadly to a headset for use with a cellular phone or PCS phone or the like. More particularly, this invention relates to a decorative headset which has a metallic casing with enamel and/or stone inlays as well as the method of making the headset.

2. State of the Art

Cellular and cellular type (e.g. PCS or satellite) telephones have become ubiquitous in recent years. In many parts of the world these wireless phones are used more than traditional wired telephones. Headsets have become a popular accessory for use with these wireless telephones. Headsets are particularly useful when using the telephone while driving or performing other activities which should require the use of both hands. Headsets are also favored by people who use their phone very frequently. For example, teenagers traditionally spend many hours on the phone every day. Now that cellular phones and service have become so inexpensive, many teenagers take their phone with them all day long. In addition, traveling business people often use their travel time to make or take telephone calls with a cellular phone. For these people who use their phone many hours a day, the headset is very advantageous. It frees the user from having to hold the phone against his/her ear for many hours a day which can actually be painful. It also allows the user to carry on activities which require the use of both hands.

There are many different types of headsets available. For example Yoon describes several different types of “ear mike phone” in U.S. Pat. No. 6,507,655, the complete disclosure of which is incorporated herein by reference. One of the most popular headsets is the type shown by Wolf in U.S. Pat. No. 6,411,722, the complete disclosure of which is incorporated herein by reference. This type of headset, which is shown schematically in prior art FIG. 14, includes an earpiece 1 which is self-supporting in the user's ear, a microphone 2 coupled to the earpiece by a flexible wire 3, and a plug 4 coupled by a flexible wire 5 to the microphone 2 and adapted to be received by a jack in the phone 6. Although these headsets have been designed to be inconspicuous, they are still unattractive.

The concept of decorating a piece of head borne audio equipment is disclosed in U.S. Pat. No. 5,581,627 to Bowser et al. for “convertible cover headphones”. As described by Bowser et al., “[i]n a method of customizing a set of headphones, the steps include (A) applying a removable decorative outer cover to at least one ear phone of the set; and (B) removing the outer cover and replacing it by a different decorative outer cover.” Though not described in much detail by Bowser et al., the decorative outer cover appears to be molded plastic with a two-dimensional design imprinted on it.

Although Bowser et al. presents an interesting way to decorate audio headphones, the methods and things described by Bowser et al. are not readily adapted for use with a cell phone-headset.

### SUMMARY OF THE INVENTION

It is therefore an object of the invention to provide a decorative headset for cell phones.

It is another object of the invention to provide methods of making a decorative headset for cell phones.

In accord with these objects, which will be discussed in detail below, the invention is based on the recognition that the popular cell phone headset, while unattractive, has a configuration similar to jewelry such as an earring. With this recognition, the present invention provides a simple manufacturing technique whereby an ordinary cell phone headset is made to look like jewelry. The first step in the process is to use metallic covers for the earpiece and the microphone rather than the black plastic covers which are presently used. The presently preferred metal is known in the jewelry art as “white metal”. It is a combination of lead and/or tin and/or antimony which is then plated with silver or gold. According to the invention, the metal covers are cast, molded, or otherwise formed to have an outer surface topography of raised and/or lowered portions. Decorative material is placed between the raised or within the lowered portions of the outer surface. According to one embodiment, the decorative material is an enamel paint or material with a similar appearance. According to another embodiment, the decorative material is real or imitation gemstones.

The resulting headset is very attractive and resembles an earring type of jewelry.

Additional objects and advantages of the invention will become apparent to those skilled in the art upon reference to the detailed description taken in conjunction with the provided figures.

### BRIEF DESCRIPTION OF THE DRAWINGS

FIG. 1 is a broken side elevational view of an earpiece according to a first embodiment of the invention;

FIG. 2 is a broken side elevational view of a microphone according to a first embodiment of the invention

FIG. 3 is a broken plan view of the back of an earpiece according to a first embodiment of the invention;

FIG. 4 is a broken plan view of the back of a microphone according to a first embodiment of the invention;

FIG. 5 is a broken side elevational view of an earpiece according to a second embodiment of the invention;

FIG. 6 is a broken side elevational view of a microphone according to a second embodiment of the invention

FIG. 7 is a broken plan view of the back of an earpiece according to a second embodiment of the invention;

FIG. 8 is a broken plan view of the back of a microphone according to a second embodiment of the invention;

FIG. 9 is a broken plan view of the front of an earpiece according to either embodiment of the invention;

FIG. 10 is a broken longitudinal section of the first embodiment of the earpiece;

FIG. 11 is a broken longitudinal section of the first embodiment of the microphone;

FIG. 12 is a broken longitudinal section of the second embodiment of the earpiece;

FIG. 13 is a broken longitudinal section of the second embodiment of the microphone; and

FIG. 14 is a broken perspective view of a prior art headset.

### ETAILED DESCRIPTION OF THE PREFERRED EMBODIMENTS

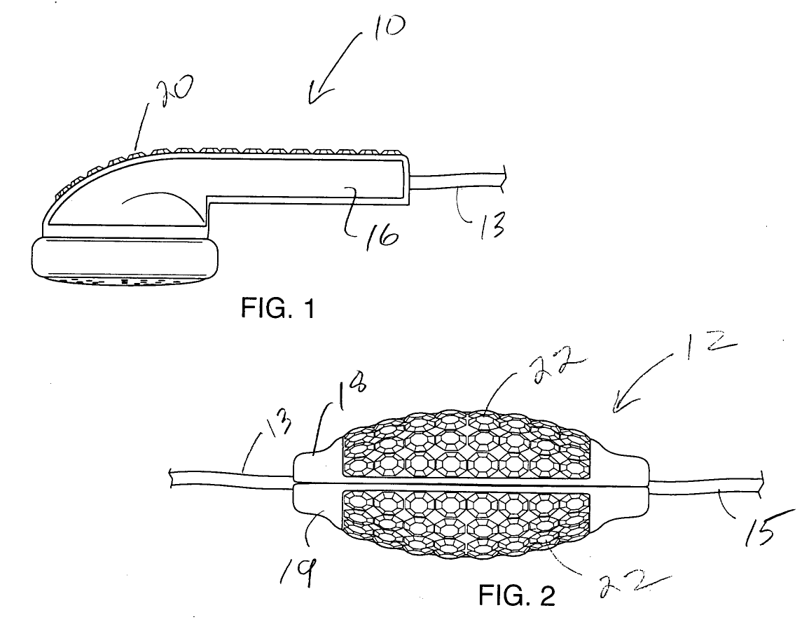

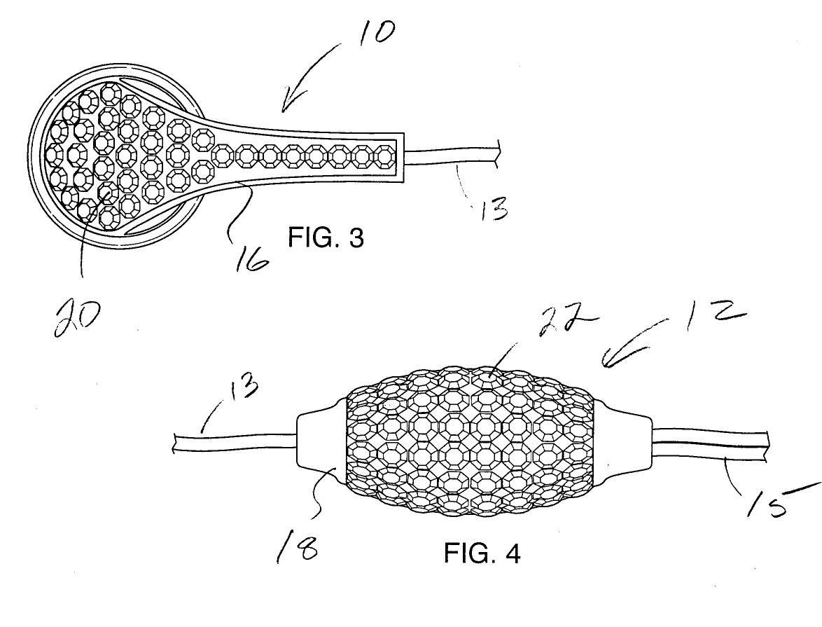

Turning now to FIGS. 1-4 and 9, a first embodiment of an earpiece 10 and a microphone 12 is shown. The earpiece 10 is coupled to the microphone 12 by a flexible wire 13 and the microphone 12 is coupled to a plug (not shown) by a flexible wire 15. The earpiece 10 has a metallic back cover 16 and the microphone 12 has metallic back and front covers 18, 19. Real or artificial gemstones 20, 22 are embedded in the covers 16, 18, 19. According to the presently preferred embodiment, the covers are made of “white metal”, a combination of lead and/or tin and/or antimony which is then plated with silver or gold. The stones 20, 22 may be all the same color or a mixture of different colored stones.

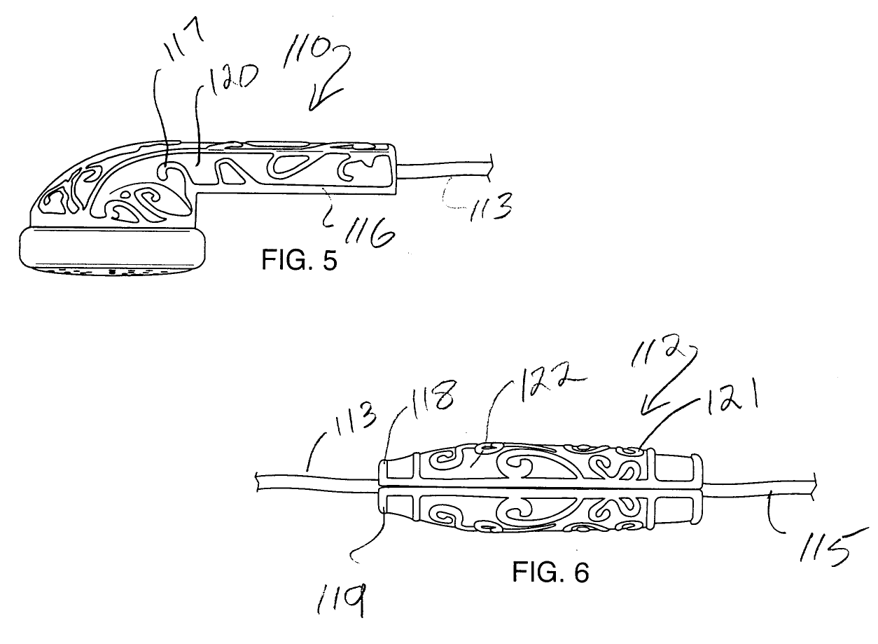

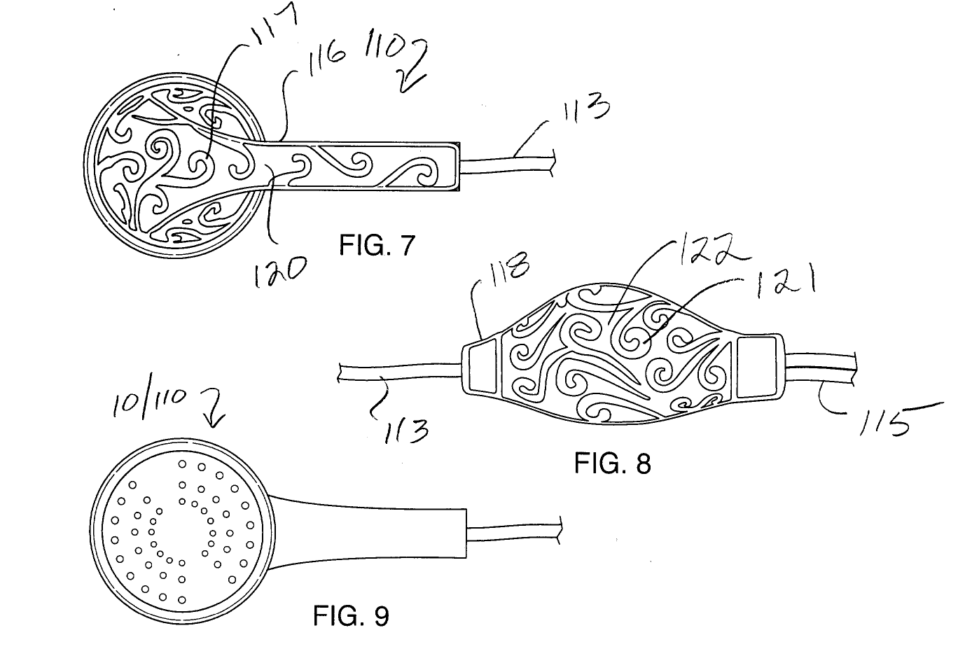

FIGS. 5-9 illustrate the second embodiment of an earpiece 110 and a microphone 112. The earpiece 110 is coupled to the microphone 112 by a flexible wire 113 and the microphone 112 is coupled to a plug (not shown) by a flexible wire 115. The earpiece 110 has a metallic back cover 116 and the microphone 112 has metallic back and front covers 118, 119. The metallic covers are formed to have a topography of raised portions, e.g. 117, 121. Enamel paint, e.g. 120, 122 is deposited between the raised portions. As seen in the figures, the raised portions of the metallic covers forms an ornamental design. According to the presently preferred embodiment, the covers are made of “white metal”, a combination of lead and/or tin and/or antimony which is then plated with silver or gold. The enamel 120, 122 may be all the same color or a mixture of different colors on different parts of the covers.

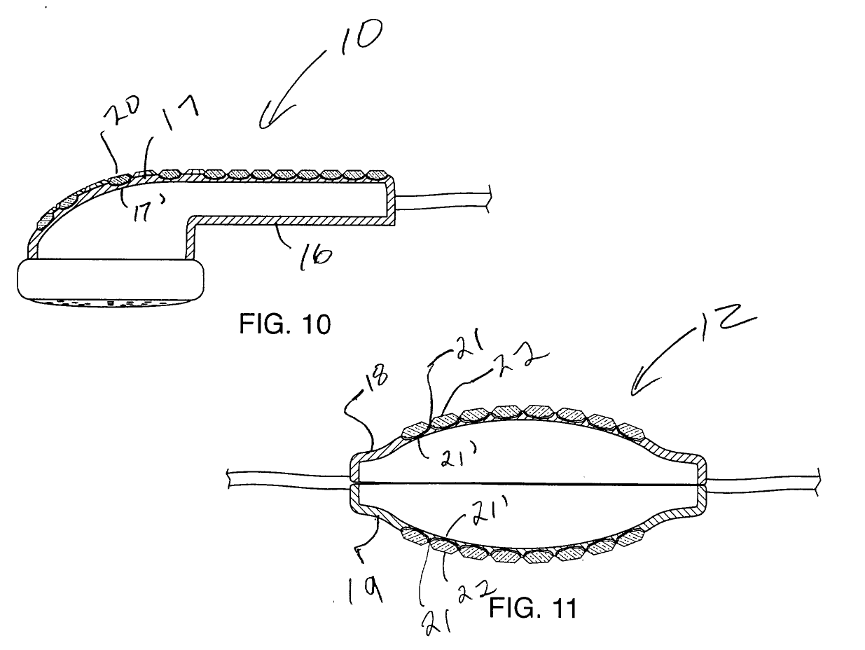

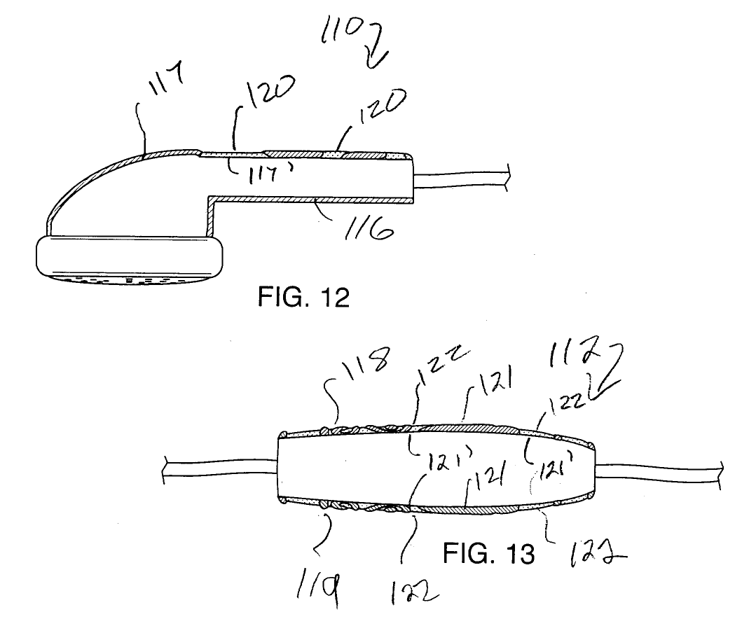

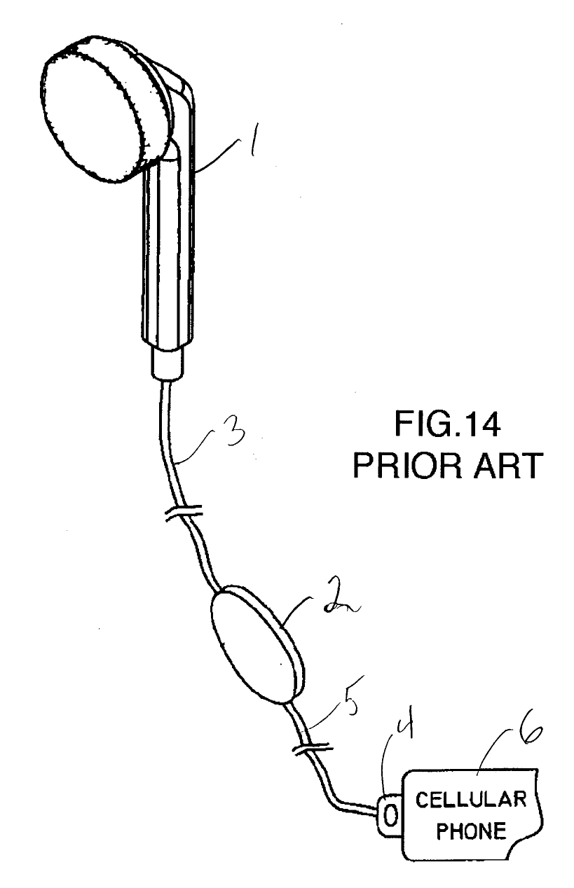

Both embodiments of the invention may be described with reference to a single inventive concept which will be appreciated by reference to the sectional drawings FIGS. 10-13. All of the metallic covers are formed to have a surface topography of raised and/or lowered portions. For example, cover 16 has raised portions 17 and/or lowered portions 17′. Covers 18 and 19 have raised portions 21 and/or lowered portions 21′. Cover 116 has raised portions 117 and/or lowered portions 117′. Covers 118, 119 have raised portions 121 and/or lowered portions 121′.

In both embodiments, decorative material is placed between the raised portions or within the lowered portions. In the first embodiment, the decorative material is real or artificial gemstones. In the second embodiment, the decorative material is enamel paint or a substance having a similar appearance.

The methods of the invention are an adaptation of the methods used to make prior art headsets. In particular, in place of molding plastic covers for the earpiece and the microphone, metallic covers as described above are formed by molding, casting, or other suitable process. The covers are formed with the topography described above which includes raised and/or lowered portions. The topography is so described because it can be formed by either raising or lowering an otherwise smooth topography. In either case, the resulting topography has portions which can be referred to as raised and portions which can be referred to as lowered, relative to each other, regardless of how they are formed. The decorative material is then applied to the lowered portions (or between the raised portions) and the covers are then assembled to the headset as in the prior art.

There have been described and illustrated herein several embodiments of a decorative headset and a method of making it. While particular embodiments of the invention have been described, it is not intended that the invention be limited thereto, as it is intended that the invention be as broad in scope as the art will allow and that the specification be read likewise. It will therefore be appreciated by those skilled in the art that yet other modifications could be made to the provided invention without deviating from its spirit and scope as claimed.

What is claimed is:

1. A decorative headset for use with a communications device, said headset comprising:
an earpiece and a microphone, wherein
one of said earpiece and said microphone has a metallic cover,
said metallic cover having an outer surface topography of one of raised and lowered portions, and
decorative material between said raised or within said lowered portions of said metallic cover.

2. The headset according to claim 1, wherein:
both said earpiece and said microphone have a metallic cover,
both said metallic covers having an outer surface topography of one of raised and lowered portions,
decorative material between said raised or within said lowered portions of both said metallic covers.

3. The headset according to claim 1, wherein:
said decorative material has the appearance of enamel.

4. The headset according to claim 1, wherein:
said decorative material has the appearance of gemstone.

5. A method of making a decorative headset having an earpiece and a microphone, said method comprising:
forming a metallic cover for one of the earpiece and the microphone so that the metallic cover has an outer surface with a topography of raised and/or lowered areas,
affixing a decorative material to the outer surface between the raised areas or within the lowered areas, and
affixing the metallic cover to one of the earpiece and the microphone.

6. The method according to claim 5, wherein:
said step of forming includes forming metallic covers for both the earpiece and the microphone,
said step of affixing a decorative material is preformed for both covers, and
each cover is affixed to respective earpiece and microphone.

7. The method according to claim 5, wherein:
the decorative material has the appearance of enamel.

8. The method according to claim 5, wherein:
the decorative material has the appearance of gemstone.

9. A decorative headset for use with a communications device, said headset comprising:
an earpiece and a microphone, wherein
one of said earpiece and said microphone has a cover,
said cover having an outer surface topography defining a plurality of one of raised and lowered portions, and
decorative material between said raised or within said lowered portions of said cover.
